(19) United States
(12) Patent Application Publication
(10) Pub. No.: US 2003/0141374 A1
(43) Pub. Date: Jul. 31, 2003

(54) Article adapted for use in sorting apparatus and associated apparatus

(76) Inventor: Mario Matkovich, Victoria (AU)

Correspondence Address: Therese A. Hendricks, Finnegan, Henderson, Farabow,, Garrett & Dunner, L.L.P., 1300 I Street, N.W., Washington, DC, 20005-3315, US

(21) Appl. No.: 10/326,974

(22) Filed: Dec. 24, 2002

Related U.S. Application Data
(63) Continuation of application No. PCT/AU01/00761, filed on Jun. 26, 2001.

(30) Foreign Application Priority Data
Jun. 27, 2000 (AU) PQ8383

(51) Int. Cl. G06K 19/00

(52) U.S. Cl. 235/487; 340/572.8

(57) ABSTRACT

An article which includes identifying means which incorporates information wherein said identifying means and the information incorporated therein is capable of being detected and recorded by a recognition unit in order that one or more characteristics of the article can be determined by correlating the information obtained from the identifying means with pre-recorded information concerning one or more characteristics of the article.

The present invention relates to articles which have been modified in a manner which allows them to be readily identified as being of a particular type or in a particular class. The articles of the present invention are particularly suited for use in automatic sorting apparatus. The present invention also relates to an automatic sorting apparatus useful in sorting the articles of the invention into batches.

The applicant has previously developed an apparatus for sorting different types of articles. Details of the previous apparatus and associated system are set out in international application PCT/AU96/00721. In this previous apparatus articles to be sorted are identified by a vision recognition unit and articles having one or more predetermined visual characteristics are selectively removed from a conveyor. In this way, articles can be sorted into discrete batches where each member of a batch is of the same type or has some common attribute. The apparatus described in PCT/AU96/00721 is particularly useful for the sorting of garment hangers. Garment hangers are manufactured in a large number of different sizes and shapes and are often marked or include a removable tab to indicate the size of the garment to be hung from the hanger. The apparatus described in the applicants earlier application enables the sorting of garment hangers into batches where all members of the batch are either the same or have some common predetermined visual characteristic or characteristics.

It is an object of the present invention to modify or incorporate within an article, means by which the article can be more readily identified either by a vision recognition unit or by other recognition equipment used with a mechanised sorting apparatus.

In the case of garment hangers and similar objects it is often the case that the article can only be identified by a vision recognition unit if a sizeable portion of the article can be viewed clearly. This means that articles being processed on an automated sorting apparatus must be spaced apart by a significant distance and/or that the articles be processed slowly and or that they be viewed by a vision recognition unit when being conveyed around a curved path (and thus separated by a larger gap on the outer side than when being conveyed in a straight line).

It is an object of the present invention to provide means by which an article which is to be sorted by such an apparatus can be identified in a manner which addresses some of the difficulties inherent in the identification of products by reference to a significant portion of their surface area.

Thus, in accordance with a first aspect of the present invention there is provided an article which includes identifying means which incorporates information wherein said identifying means and the information incorporated therein is capable of being detected and recorded by a recognition unit in order that one or more characteristics of the article can be determined by correlating the information obtained from the identifying means with pre-recorded information concerning one or more characteristics of the article and wherein said identifying means is moulded onto or within the article.

Preferably, the article is a garment hanger.

It is often desirable that an article be identifiable by reference to a range of different criteria. For example, where the article is a garment hanger that is made to be reused it may be desirable to record the number of times which the particular garment hanger has been sorted by the apparatus. In such a case, it is preferable that the identification means incorporate information which is unique for each garment hanger which is to be handled by the sorting apparatus. In this way, a record can be maintained of the number of times any particular hanger has been returned for resorting and reuse. Garment hangers may be indelibly marked with a size indication, the garment hanger might include clips of a particular type or the arms of the hanger may be of a particular length. It may be desirable to sort hangers according to any one of these characteristics or some other characteristic. Some of these characteristics may be visually recognisable and others not and, accordingly, it is preferable that the identification means incorporate information which may be correlated with pre-recorded information to identify a plurality of different characteristics of the hanger to be sorted and batched. The same applies for other articles.

The identification means is moulded onto or into some part of the article.

It is preferred by the applicant that the article be moulded so to include the identifying means. If the identifying means, is otherwise attached it may be removed or may fade over time thus becoming difficult to read. In one embodiment of the invention the article is moulded so to include a pre-determined number of identifying formations (preferably tabs) optionally in pre-determined orientations uniquely identifying an article or identifying articles as having one or more visual or other characteristics.

When a garment hanger is moulded incorporating identifying tabs it is preferred that a specific location be provided so that the tabs may be readily viewed by a vision recognition unit.

Such a location may be anywhere on the garment hanger. For example the identifying tabs might be provided along the top or the side of the hook of the hanger. Preferably identifying tabs are located centrally and in the section of the hanger immediately beneath the hook. Most preferably the hanger includes an aperture with identifying tabs extending inwardly from the periphery of the aperture—the number and orientation of the tabs relative to each other providing the identifying information. The use of an aperture, means that the identifying tabs can form a silhouette against light viewed through the aperture and this enhances vision recognition of each tab and its orientation. Desirably the aperture is asymmetric or has at least one straight side so that the orientation of the tabs can easily be checked against a reference in the aperture without viewing other parts of the hanger. For example the aperture may be a square, rectangle, triangle, oval or other similar shape.

Alternatively the identifying information may be provided by utilising one or more slots or cut outs extending outwardly in different orientations and disrupting the continuity of the periphery of the aperture. The aperture may be circular with a predetermined number of individual identifying tabs located within the aperture at different locations around its periphery to represent a hanger of a particular type. Preferably the tabs are of such size that they can be readily discerned to the eye thus facilitating easier manual sorting by reference to the number and orientation of the tabs. Of course the primary benefit of the invention is obtained by use of this form of identification in automatic systems.

It will be appreciated that a large number of image identifying tab configurations can easily be accommodated using this system (e.g. by using twelve different orientations similar to the positions of the numbers on a clock face one can mould twelve different configurations when using a single tab. By using multiple tabs in different orientations there are several hundred potential combinations).

Preferably the individual tabs are located wholly within the aperture so that there is a lower risk of the tabs being broken off the hanger or otherwise being damaged when the hanger is in normal use.

The identifying means may be located on an edge of the body portion of the hanger between the hook and the arms of the hanger. Where a sizing indicator is attached to the hanger (especially when it is attached to the back of the hook or on the body portion) the identifying means may be located on the sizing indicator. It is preferred that the hanger incorporate a hook which includes a planar surface portion on the back of the hook which is substantially vertical when the hanger is suspended freely from its hook and that the identifying means be moulded on this portion of the hanger. In this way, garment hangers being sorted by automated means can be loaded onto a conveyor and can be spaced relatively closely (i.e. face to face) without the risk of the identification means being obscured by other articles being conveyed. Further, by utilising an identifying means on the back of the hook of the garment hanger, it is possible to position a recognition unit adjacent to a conveyor in a section where the hangers are being conveyed in a straight path and are side by side. This enables processing of articles in a sorting and batching apparatus at higher recognition rates than an apparatus that requires recognition by reference to visual characteristics of a significant portion of the article.

Alternatively, the identification means may be a magnetic component or tape or a computer chip which may be coded with information so that the article may be identified either by being a member of a particular class of goods or alternatively by reference to a number of different characteristics together with a unique identification number. A computer chip does not need to be visible and may be conveniently moulded into the hanger when it is being made. Preferably, a computer chip if used would be incorporated into the body portion of the hanger between the hook and arms of the hanger.

In accordance with a further aspect of the present invention there is provided an apparatus for sorting from a group of different articles at least one batch of articles where members of the batch are either the same or have some unifying characteristic and where the articles to be sorted include identifying means moulded onto or into the article which incorporates information, said apparatus including:

(a) conveying means for transporting the articles along a predetermined path;

(b) at least one recognition unit that is capable of detecting and recording information incorporated in the identifying means included in the articles to be sorted;

(c) correlation means capable of correlating the information obtained from the respective identifying means with pre-recorded information concerning one or more characteristics of the articles so to identify such characteristics for the respective articles detected by the recognition unit; and

(d) removal means for selectively removing those articles from the conveying means which have been identified as having one or more predetermined characteristics.

Preferably, the apparatus is capable of sorting from a group of different articles two or more batches of articles where members of each batch are either the same or have some unifying characteristic. For example, where the apparatus is used to sort garment hangers the identifying means included within each of the articles might include information which can be used to determine that the hanger which has been detected is of a particular type. If for example ten different types of hangers are to be sorted by the apparatus each of the ten types would include identifying means which could be detected and recorded so to identify each of the hangers as being either of type 1, 2, 3, 4, 5, 6, 7, 8, 9 or 10. The apparatus in such an example would thus be adapted preferably to sort each of the ten different hanger types into ten batches where each of the hangers in each batch were the same.

In such a case, it is preferred that the apparatus include separate and dedicated removal means for each of the types of articles which are to be removed from the conveying means. Each removal means is preferably associated with a collection bay at which the articles are maintained in respective sorted batches.

Preferably, the apparatus is used in conjunction with articles which incorporate moulded integral identifying formations. This identification means can be used as the sole identifying means. In this embodiment the identifying means incorporates information which may be correlated with pre-recorded information concerning various characteristics of the article. In such case, the recognition unit is a vision recognition unit. Alternatively, the articles may include other identifying means such as a computer chip incorporating the relevant information and in such case the recognition unit is one which is adapted to detect and record information incorporated in the computer chip.

Most preferably, the apparatus is capable of conveying and sorting garment hangers. In such an embodiment, it is preferred that the conveying means incorporate holders suitable for conveying hangers in face to face orientation in a direction transverse to the plane in which the arms of the hanger lie.

In this arrangement, it is preferred that the identifying means be located on an edge of the hanger and most preferably along an edge of the body portion of the hanger or along an edge of the back of the hook of the hanger. In such case, the recognition unit may be positioned adjacent to the conveying means in a section of the conveying means where the articles are transported in a straight line—the identifying means being plainly visible from a position adjacent to the predetermined path.

Apart from the recognition unit and the means by which the articles are identified, the apparatus preferably also includes each of the features of the apparatus identified in PCT/AU96/00721 the contents of which is herein incorporated by reference.

The apparatus of the present invention may be used in conjunction with one or more vision recognition units of the type described in PCT/AU96/00721. For example, it may be expedient to utilise a vision recognition unit which captures a full image of the article being sorted to check for information not readily included on a bar code or alternatively which cannot be detected by reading such identifying means (e.g. damaged product).

In accordance with a further aspect of the proposed invention there is provided a method for sorting from a group of different articles at least one batch of articles where members of the batch are either the same or have some unifying characteristic which includes:

(a) conveying articles which include identifying means moulded onto or into the article along a predetermined path;

(b) using a recognition unit to detect the identifying means and to record information incorporated therein;

(c) correlating the information obtained from the respective identifying means with pre-recorded information concerning one or more characteristics of the articles;

(d) collecting one or more batches of articles wherein articles in any one batch, have been identified as having one or more common characteristic.

Preferred embodiments of the invention are hereinafter described with reference to the accompanying drawings in which:

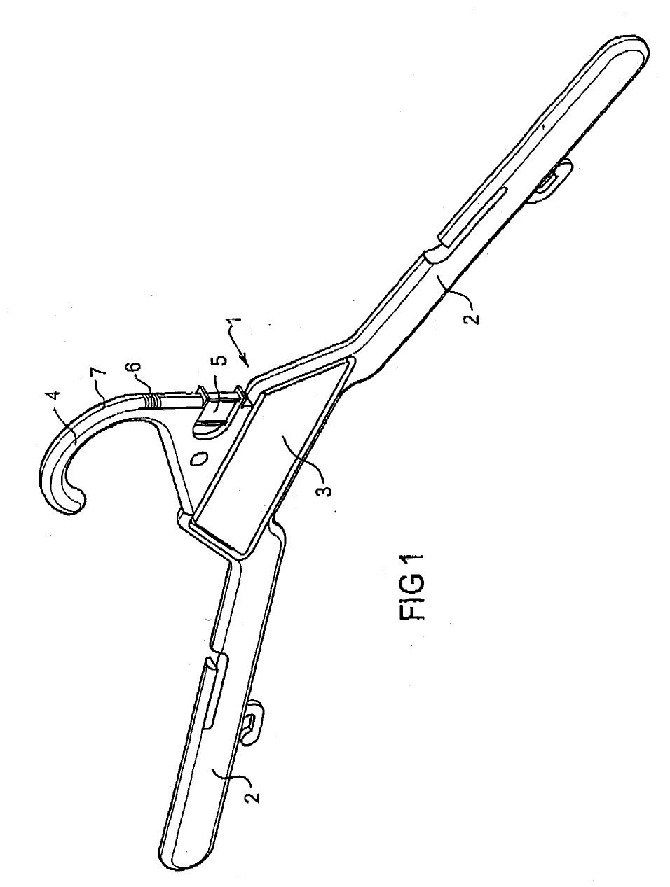

FIG. 1 is a perspective view of a hanger marked with identifying means in accordance with the invention;

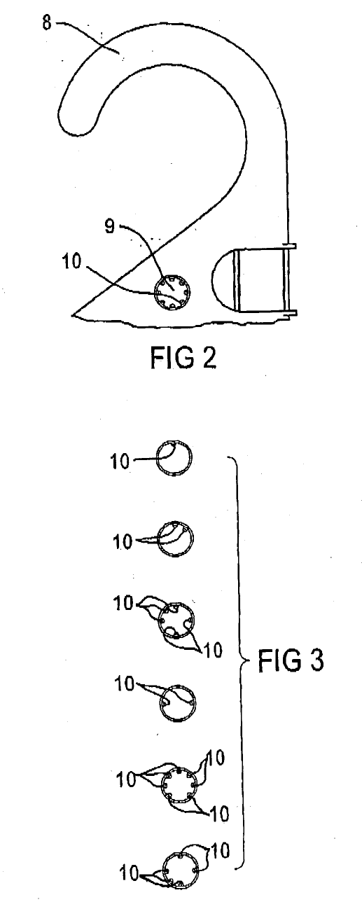

FIG. 2 is a front view of a hanger hook incorporating a moulded tab identification system;

FIG. 3 is a set of examples of different moulded configurations of the moulded tab identification system shown in FIG. 3;

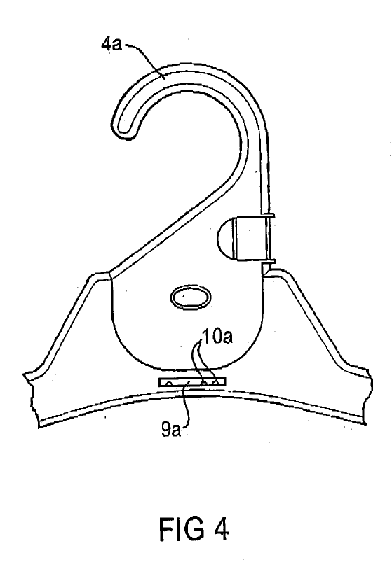

FIG. 4 is a front view of the central portion of a garment hanger incorporating an alternative moulded tab identification system;

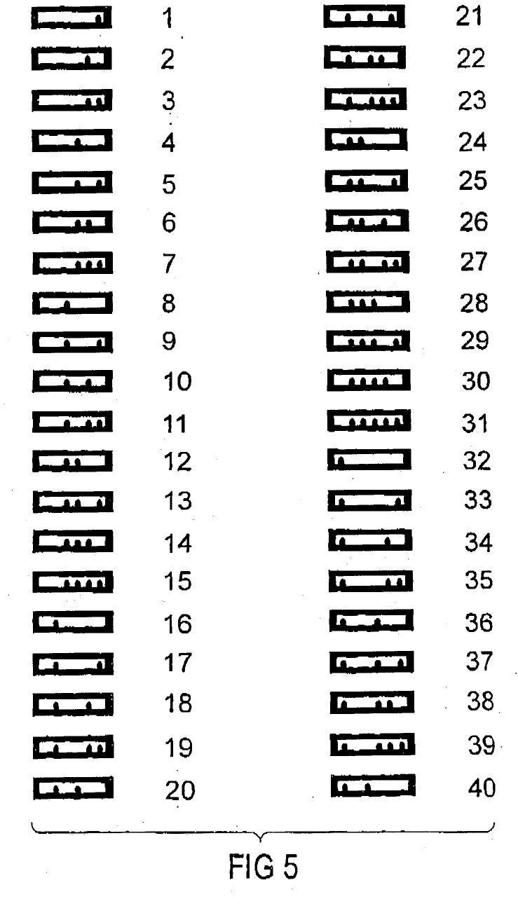

FIG. 5 is a set of examples of different moulded configurations of the moulded tab identification system shown in FIG. 4 showing binary conversions; and

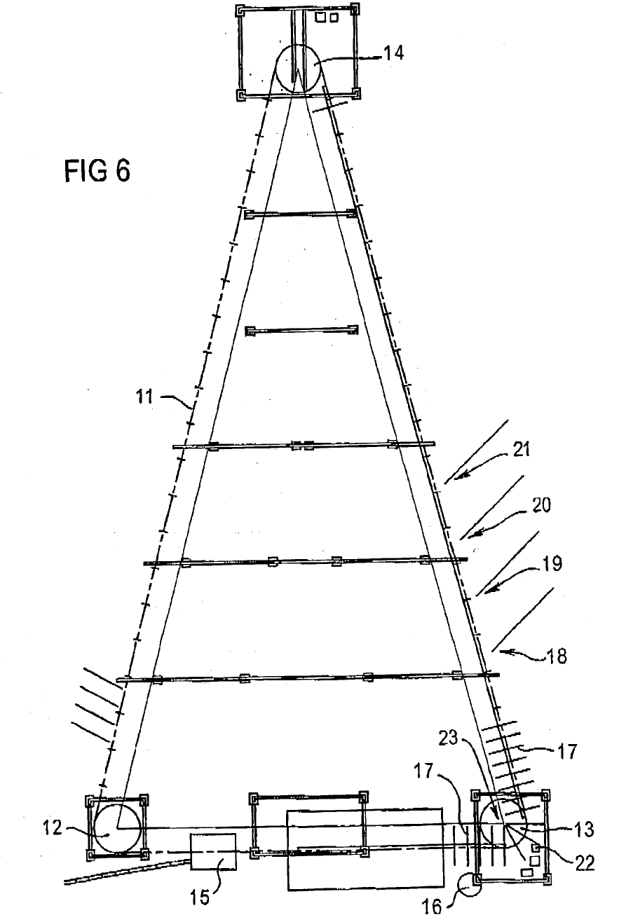

FIG. 6 is a plan view of an apparatus in accordance with the invention.

Referring first to FIG. 1 there is shown a garment hanger 1 which has arms 2, a body portion 3 and a hook 4. Towards the base of the hook there is provided a slot 5 intended for receiving a sizing indicator tab which is not shown. Identifying means 6 is moulded into hanger 1 on the back face 7 of hook 4. When hanger 1 is suspended from hook 4, face 7 is substantially perpendicular. As such, identifying means 6 faces directly outwardly from the hanger when it is suspended from the hook in a location which is convenient for ready identification by a reader located adjacent to the hanger when being conveyed on a sorting apparatus such as that shown in FIG. 4.

In FIG. 2 there is shown the hook 8 of an alternative hanger the bottom of which is not shown but may be of any known configuration. A circular aperture 9 is positioned towards the bottom of the hook and is centrally disposed. Within the circular aperture 9 there is positioned one or more integrally moulded identification tabs 10. In the embodiment shown there are eight such tabs. By selecting different numbers and orientations of such tabs when moulding the hanger a number of possible combinations arise as can be seen from the combinations shown in FIG. 3. The tabs 10 may stand proud of the surface of hook 8 but preferably they are wholly contained within the aperture 9 so to minimise damage in subsequent use of the hanger.

In FIG. 4 there is shown the hook 8a of an alternative hanger the arms of which are not shown but may be of any known configuration. A rectangular aperture 9a is positioned towards the bottom of the central portion of the hanger and is centrally disposed. Within the rectangular aperture 9a there is positioned one or more integrally moulded identification tabs 10a. By selecting different numbers and by differently positioning such tabs when moulding the garment hanger one can produce a binary identification system with the tabs correlating to numbers as set out in FIG. 5.

Turning to FIG. 6, there is illustrated in plan view an apparatus in accordance with the invention. The apparatus includes a conveyor 11 for transporting garment hangers along the triangular path shown. Conveyor 11 is driven around three separate wheels, 12, 13 and 14. Garment hangers of the type shown either in FIG. 1 or 2 which incorporate identifying means are loaded onto conveyor 11 at position 15 by any suitable loading apparatus. For example, the hangers may be loaded onto the conveyor 11 by apparatus such as that described in the applicant's International Application PCT/AU96/00722 (the contents of which is herein incorporated by reference). A reader 16 is located adjacent to conveyor 11 for detecting and recording the information contained on each of the respective hangers 17 as they are passed by the recognition unit 16.

Preferably, recognition unit 16 also includes correlation means for correlating the information obtained from the identifying means on the respective garment hangers with pre-recorded information identifying the type of hanger being conveyed past the recognition unit. Removal means 18, 19, 20 and 21 are adapted to remove the hangers 17 from the conveyor 11. Preferably each garment hanger is retained on an individual article holder. As each of the respective hangers pass by recognition unit 16 information is recorded and correlated against information stored on a memory within the correlation means allowing the identification of the garment hanger as being of a particular type or as having particular characteristics. The recognition unit 16 incorporates processing means to match the information concerning the type or characteristic of hanger which has passed it with the specific article holder on which the hanger is retained. The system is coordinated such that the appropriate removal means designated for a particular hanger type (either 18, 19, 20 or 21) will be activated as the article holder comprising the identified hanger is conveyed to any one of these respective locations. It will be appreciated that any number of removal mechanisms can be utilised for sorting by reference to any one or more of any pre-determined characteristics or alternatively to sort in batches having a specified number of particular types of hangers sorted together. Vision recognition unit 22 may be similarly coordinated either to work in tandem with recognition unit 16 or to be activated only when recognition unit 16 does not identify any particular garment hanger which passes by it. A printer 23 associated with turntable 13 may be activated by recognition unit 16 or vision recognition unit 22 to print or otherwise mark garment hangers which have not been recorded as incorporating identifying means by recognition unit 16 and the features of which have been identified by vision recognition unit 22.

The present invention thus provides a convenient and automated system for the sorting and batching of various different articles into homogenous or selected heterogeneous groups. It enables the identification of various characteristics of articles which are not otherwise detectable by vision recognition based on the shape and appearance of the article. Information such as the date of manufacture of the article and the number times it has been recycled can be recorded by reference to the identifying means.

In this specification and in the claims the expression “incorporates information” and other similar expressions such as “information incorporated therein” when in reference to an identifying means on an article, means that the visual or other characteristics of the identifying means can be converted into numbers, letters and or other symbols or forms from which facts and/or data can thereafter be ascertained.

It will be appreciated that various modifications and/or improvements can be made to the apparatus and to the articles hereinbefore described without departing from the spirit or ambit of the invention as defined in the following claims.

The claims defining the invention are as follows:

1. An article which includes identifying means which incorporates information wherein said identifying means and the information incorporated therein is capable of being detected and recorded by a recognition unit in order that one or more characteristics of the article can be determined by correlating the information obtained from the identifying means with pre-recorded information concerning one or more characteristics of the article and wherein said identifying means is moulded onto or within the article.

2. An article as claimed in claim 1 wherein the article is moulded and the identifying means includes one or more formations which can be used to identify characteristics of the article.

3. An article as claimed in claim 2 wherein the one or more formations are tabs located within an aperture in the article.

4. An article as claimed in any one of the previous claims wherein the identifying means includes a shaped aperture.

5. An article as claimed in claim 4 wherein the information may be provided by utilizing one or more slots or cut-outs extending outwardly in different orientations and disrupting the continuity of the periphery of the aperture.

6. An article as claimed in claim 1 wherein the identifying means is a magnetic component or a computer chip.

7. An article as claimed in claim 6 wherein the identifying means is a computer chip which is moulded within the article.

8. A garment hanger which includes identifying means which incorporates information, wherein said identifying means and the information incorporated therein is capable of being detected and recorded by a recognition unit in order that one or more characteristics of the garment hanger can be determined by correlating the information obtained from the identifying means with pre-recorded information concerning one or more characteristics of the garment hanger and wherein said identifying means is moulded onto or within the garment hanger.

9. A batch of garment hangers of the type as claimed in claim 8 wherein the information incorporated on any one of the garment hangers is different to the information incorporated on any of the other garment hangers in the batch.

10. A garment hanger as claimed in claim 8 wherein said identifying means includes an aperture with identifying tabs extending inwardly from the periphery of the aperture.

11. A garment hanger as claimed in claim 10 wherein the aperture is located centrally and in the section of the hanger beneath the hook.

12. A garment hanger as claimed in either one of claims 10 or 11 wherein the aperture is asymmetric or has at least one straight side.

13. A garment hanger as claimed in either one of claims 10 or 11 wherein the aperture is circular and the identifying tabs are located within the aperture at different locations around its periphery.

14. A garment hanger as claimed in either one of claims 10 or 11 wherein the aperture is a rectangular slot.

15. A garment hanger as claimed in claim 10 wherein said identifying tabs are located wholly within the aperture.

16. A garment hanger as claimed in claim 8 wherein said identifying means is a magnetic component or a computer chip.

17. A moulded garment hanger which incorporates an aperture wherein one or more moulded formations are located within the aperture for the purpose of enabling one or more attributes of the garment hanger to be derived by reference to the disposition, size, number or other attribute of the formation or formations located within the said aperture.

18. A moulded garment hanger as claimed in claim 17 wherein said formations are tabs which are located wholly within the aperture.

19. A moulded garment hanger as claimed in either one of claims 17 or 18 wherein the said aperture is located centrally and in the section of the garment hanger beneath the hook.

20. An apparatus for sorting from a group of different articles at least one batch of articles where members of the batch are either the same or have some unifying characteristic and where the articles to be sorted include identifying means moulded onto or into the article which incorporates information, said apparatus including:
(a) conveying means for transporting the articles along a predetermined path;
(b) at least one recognition unit that is capable of detecting and recording information incorporated in the identifying means included in the articles to be sorted;
(c) correlation means capable of correlating the information obtained from the respective identifying means with pre-recorded information concerning one or more characteristics of the articles so to identify such characteristics for the respective articles detected by the recognition unit; and
(d) removal means for selectively removing those articles from the conveying means which have been identified as having one or more predetermined characteristics.

21. The apparatus as claimed in claim 20 which is capable of sorting from a group of different articles, two or more batches of articles where members of each batch are either the same or have some unifying characteristic.

22. An apparatus as claimed in either one of claims 20 or 21 which includes separate and dedicated removal means for each of the types of articles which are to be removed from the conveying means.

23. An apparatus as claimed in any one of claims 20 to 22 wherein the articles to be sorted are articles of the type claimed in any one of claims 1 to 19.

24. An apparatus as claimed in any one of claims 20 to 23 wherein the apparatus is capable of conveying and sorting garment hangers.

25. A method for sorting from a group of different articles at least one batch of articles where members of the batch are either the same or have some unifying characteristic which includes:
(a) conveying articles which include identifying means moulded onto or into the article along a predetermined path;
(b) using a recognition unit to detect the identifying means and to record information incorporated therein;
(c) correlating the information obtained from the respective identifying means with prerecorded information concerning one or more characteristics of the articles;
(d) collecting one or more batches of articles wherein articles in any one batch have been identified as having one or more common characteristic.

26. A method as claimed in claim 25 wherein the articles being sorted are of the type as claimed in any one of claims 1 to 19.

27. A method as claimed in either one of claims 25 or 26 wherein said articles are garment hangers.

28. A garment hanger substantially as hereinbefore described with reference to what is shown in any one of FIGS. 1 to 5.

29. An apparatus substantially as hereinbefore described with reference to what is shown in FIG. 6.

30. A method substantially as hereinbefore described with reference to what is shown in any one of FIGS. 1 to 6.
